(19) United States
(12) Patent Application Publication
(10) Pub. No.: US 2007/0192452 A1
(43) Pub. Date: Aug. 16, 2007

(54) Method and system of coordinating control point state in a home environment

(75) Inventors: Yu Song, Milpitas, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/354,406

(22) Filed: Feb. 14, 2006

(51) Int. Cl. G06F 15/173

(52) U.S. Cl. 709/223

(57) ABSTRACT

A distributed coordination system for a home network environment provides data and functional coordination among multiple control points in a networked home environment. Data and other services (e.g., events) are duplicated among multiple control points. The duplication allows multiple control points to function independently regardless of other control points. Coordination involves the synchronization of runtime state among multiple entities in the network. The distributed coordination system uses a weak consistency model to replicate data and coordinated functions (e.g., event notification) among heterogeneous controlling devices, such as DVD player, speaker, thermostat, with low overhead in a home network. The data replication and function coordination enable software components and/or users to access them without tying themselves to ensuring certain data on a specific control point. In addition, in case, one or more control points go offline, the replicas on other available control points can continue to serve requests and share state.

### FIELD OF THE INVENTION

The present invention relates generally to control of devices in a network, and more particularly, to coordinating control point state in a home network environment.

### BACKGROUND OF THE INVENTION

A control point in a network such as a home network is a device that can control other devices. For example, a home desktop PC can be a control point. It can send commands to other devices, such as DVD player, stereo speakers. Another example is a TV. A TV can be a control point that controls other devices in a home as well. However, unlike enterprise network environments where devices are well managed, and especially where servers are always online to serve requests, a control point in a home network can be powered off anytime. For example, a TV, a home desktop PC, can be powered off any time whenever they are not used. On the other hand, a control point contains runtime and other information that needs to be online to serve user requests. For example, a control point can contain information about a play list of favorite sound tracks that a user has hand-picked from several different albums. When the control point is powered off, the play list information can not be obtained.

Another example is event notifications and their associated internal application states. A user uses a control point to stream a DVD movie from a DVD player to a TV. The event is sent to the second control point to inform the current states of the DVD player and the TV. As a result, if a second user tries to play another movie using the occupied DVD player through the second control point fails, because, the second control point knows that the DVD player is playing a movie already. Another example is the session migration. A user uses a first control point to start a DVD movie from a DVD player to a first TV. In the middle of the playing, the user may decide to pause the DVD movie session and do something else. At a later time, the user wants to continue the session, but on a second TV using a second control point. Because the session data is stored in the first control point and coordinated to the second control point, when the user uses the second control point, the user can see the exact session and its state on the second control point. The user can simply add the second TV to the session and remove the first TV from the session; and continue to watch the movie on the second TV from where it is left off. Thus, coordination among the control points must exist to enable the same data and integrated experience.

One prior solution is a centralized approach where a device such as the home desktop PC, is considered the central control of home entertainment. This approach takes advantage of hardware and software resource in the controlling device. However, the centralized approach has its obvious disadvantages. It considers the controlling device as the central server. In case when the PC is turned off, users cannot enjoy entertainment in a home network.

Unlike enterprise network environments that have complex network topology, a home network is usually simple in its network topology. Other conventional approaches take advantages of an ad-hoc network topology, and allow devices and application to share a single, logic data segment among multiple devices. Although suitable for data replication among control points, such approaches are designed to share memory among devices that have more complex design and implementation. Because memories are shared among devices, it does not provide failover and load balance capabilities.

### BRIEF SUMMARY OF THE INVENTION

An object of the present invention is to provide a distributed coordination system in a home network environment. In one embodiment, the present invention provides a distributed system that provides data, devices and applications states functional coordination among multiple control points in a networked home environment. Runtime states (e.g., devices states), and functional coordination (e.g., event notification occurrences) are duplicated/replicated among multiple control points. The replication allows multiple control points to function independently regardless of other control points.

In one implementation of the present invention, coordination involves the synchronization of runtime states among multiple entities, such as devices, applications, in the network. The distributed coordination system uses a weak consistency model to replicate runtime states, and functional coordination, (e.g., event notification occurrences) among heterogeneous controlling devices with low overhead in a home network. The runtime states replication and functional coordination enable software components and/or users to access them without tying themselves to a specific control point to ensure runtime states and functions are always available regardless availability of control points. In addition, in case, one or more control points become offline, the replicas on other available control points can continue to serve requests and share state.

These and other features, aspects and advantages of the present invention will become understood with reference to the following description, appended claims and accompanying figures.

### BRIEF DESCRIPTION OF THE DRAWINGS

FIG. 1 shows a block diagram of an embodiment of a network implementing control point coordination according to an embodiment of the present invention.

FIGS. 2 and 3 show example steps of an embodiment of a control point coordination method according to an embodiment of the present invention which is implemented in the network of FIG. 1

### DETAILED DESCRIPTION OF THE INVENTION

In one embodiment, the present invention provides a distributed system that provides runtime states and functional coordination among multiple control points in a networked environment, such as a home network environment. Runtime states (e.g., devices states and applications states) and functions (e.g., event notification occurrences) are duplicated/replicated among multiple control points. The replication allows multiple control points to function independently regardless of other control points.

In one implementation of the present invention, such coordination involves the synchronization of runtime states among multiple controlling devices in the network. The distributed coordination system uses a weak consistency model to replicate runtime states (e.g., devices states, applications states) and functions (e.g., event notification occurrences) among heterogeneous controlling devices with low overhead in a home network. The runtime states and functions replication enable software components and/or users to access the synchronized data and runtime states without tying themselves (e.g., software components, users) to a specific controlling device, and as a result, in case, one or more control points go offline, the replicas on other available control points can continue to serve requests and share states for the software components and/or users.

Coordination of multiple control points in a home network environment enables control points to keep consistency with regard to runtime states (e.g., the elapsed time of a movie play from the start) and deliver expected services to users independently and collaboratively. The control point independence means a user can use any of the control points to control the devices in a home network. Collaboration means multiple control points coordinate each other in terms of data, and functions. For example, when a user uses a first control point to play a movie, the elapsed time of the movie is replicated among multiple control points. Such replication enables the user to pause the movie, turn off the first control point, and continue the movie where it is left off using the second control point.

A distributed middleware system according to the present invention in a local area network, such as a home network environment, allows control points to coordinate their runtime states and functions such that the control points can respond to users in consistent and independent manner. In one example, the distributed middleware system is implemented as coordinators in the control points, described below.

An example control point coordination system (distributed middleware system) allows a first application to save its runtime data (state) in a first control point. The first control point coordinates with a second control point. Thus allows a second application that connects to a second control point, to query the second control point about state of the device states that first application controls as if the first application saved the device states on the second control point. In addition, the second application can receive events from the second control point, which are generated by the first control point as the result of the first application. For example, an event, for example, a playing movie session paused event, is generated from the first control point and propagated to the second control. In this embodiment, a client device is a device that is used to control other devices in the network via a control point. The client device has a user interface, such as a screen, speaker/headphone, for user interaction such as command/control and feedback. A device refers to any networked device that is controllable by a user via client devices/control points, for example, a device can be a DVD player, a refrigerator, and etc.

In this embodiment of the present invention, a weak consistency model is utilized in control point coordination. The weak consistency model does not guarantee that sequence of data writing (called as a transaction) on a control point A is the same as that on a control point B. For example, a data write sequence on the control point A can be “writing ‘1’, then ‘2’, then ‘3’, and then finally, ‘4’”, while the sequence on the control point B could be ‘2’->‘3’->‘1’->‘4’. However, each data write on a control point is atomic which means that a second data write cannot commence if a control point is in the process of writing the first data. For example, in the previous of the first control point, the first control point cannot write ‘2’ before it finishes writing ‘1’. To ensure a transaction is atomic, a series of messages are used to indicate the start and the end of a transaction. When a control point receives a “start-of-a-transaction” request message from another control point, the control point can start the transaction if there are no other transactions that are being processed/performed by the control point; otherwise, the control point places the request into a transaction queue.

Although data synchronization among control points employs the weak consistency model, data that represents runtime states (e.g., devices and application states) and functions (e.g., event notification occurrences) on control points eventually (i.e., after a very short period for example, after few seconds) reach the convergence point where data are same on every control point because data updates (e.g., devices states) in a control point (e.g., in a home network) is not frequent, therefore, in most case the transaction queue on a control point is short and can be processed quickly. The advantage of the weak consistency model is the design simplicity of synchronization method, and responsiveness of the network for small devices. Processing applications and client device requests consumes time. On the other hand, users demand instant response for their commands. This is problematic for consumer electronic (CE) devices in a home because typical CE devices have less computational power than desktop PCs. The responsiveness comes from the fact that each control point does not need to ensure its runtime states are in sync with other control points before it processes new data updates from a client device. The example embodiment described herein employs recording of each data update transaction, in a monotonically increasing sequence number, indicating how many updates the control point has done. For example, the sequence number always starts from 1 and increases by 1, on each control point. This number is used by the control point for comparison of number of transactions that have been processed by other control points. If the numbers match, it means data is coordinated among control points. If not, a control point with smaller sequence number asks the control point with largest sequence number for the latest copy of the data. For example, a first control point increases its sequence number by 1 every time it updates its runtime states, it also tells other control points about its latest sequence number. Likewise, a second control point increases its sequence number by 1 every time it updates its runtime states, and tells the first control point about its latest sequence. Assume that latest sequence number of the first control point is 1000, and the first control receives the latest sequence number of the second control point is 1001. The first control point knows that the second control point contains the latest runtime states. So, the first control point will obtain a copy of the second control point runtime states and updates its sequence number to that of the same of the second control point.

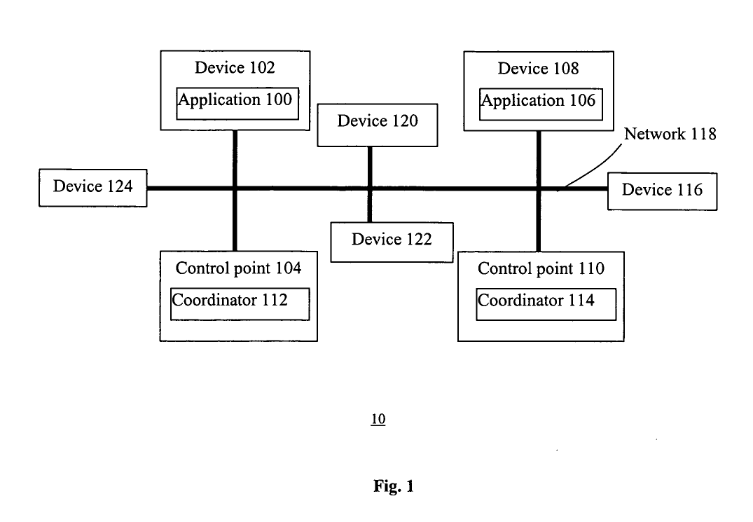

Referring now to FIGS. 1-3, in a preferred embodiment of the present invention, a control point coordination system 10 (FIG. 1 shows a block diagram of the devices, control points and applications), includes: (1) a first application 100 in a first client device 102 and a first control point 104; (2) a second application 106 in a second client device 108 and a second control point 110; (3) a device 116, 120 and 122 that connects to the first control point 104 and the second control point 110, can be controlled by both control points.

The first application 100 and the second application 106 control the device 116, 120, and 122 through the first control point 104 or the second control point 110. In addition, the first application 100 and the second application 106 receive events regarding the states updates of the device 116, 120, and 122 via events from the first control point 104 and the second control point 110 respectively. The first application 100 communicates with the first control point 104. The second application 106 communicates with the second control point 110. The first control point 104 includes a first coordinator 112 and the second control point 110 includes a second coordinator 114. The first coordinator 112 coordinates with the second coordinator 114. During the lifetime of the first application 100, the first application 100 sends requests to the first control point 104 and consequently updates the runtime states in the first control point 104. During the lifetime of the second application 106, the second application 106 sends requests to the second control point 110 and consequently updates the runtime states in the second control point 110. The client devices 102, 108, the first control point 104, the second control point 110 and the device 116, 120, and device 122 are connected via network 118.

The network 118 can be wired or wireless. The wired network can be, for example Ethernet. The wireless network can be, for example, IEEE 802.11x. The runtime states in the coordinators 112 and 114 are stored as a triplet of (subject, relation, object). The subject, relation and object are represented in text such that they are independent of hardware and software platforms, and can be interpreted easily.

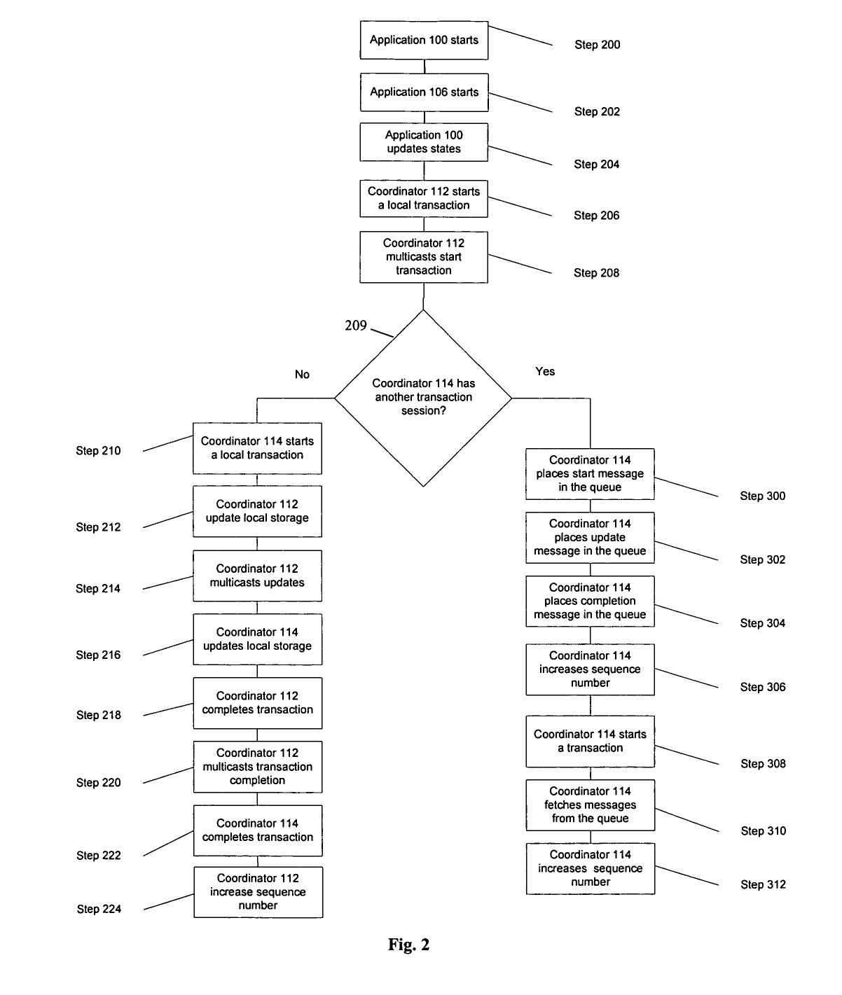

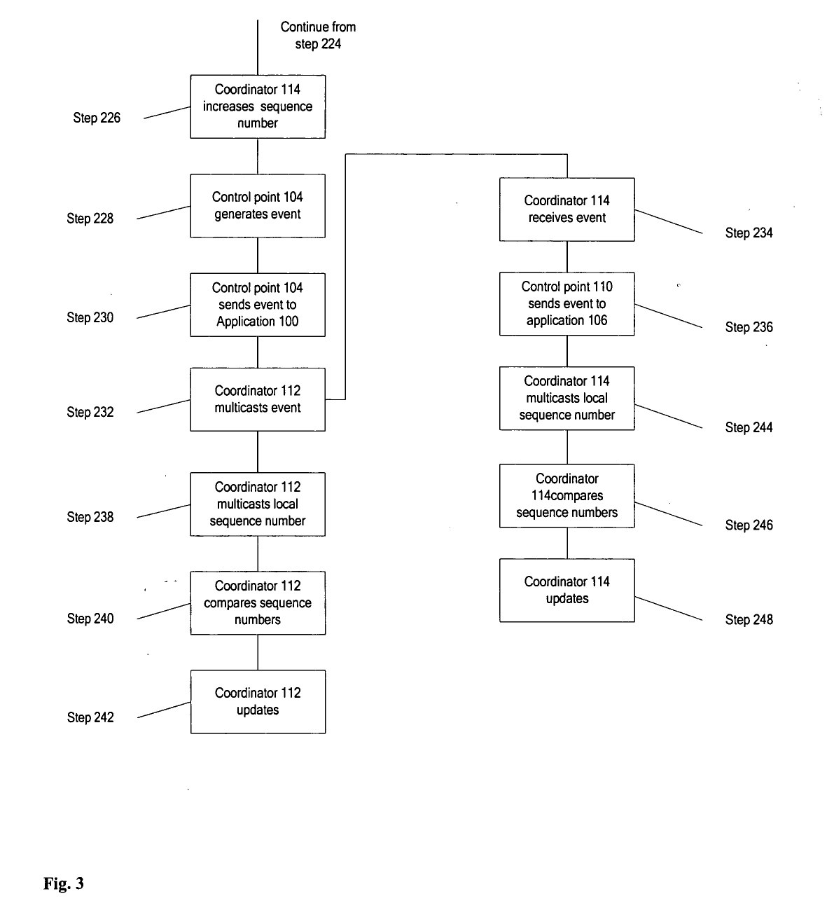

Referring now to the flowchart of example steps in FIGS. 2-3, a step-by-step description of persistent states updates among multiple control points (i.e., the control point 104 and 110) is now described (it is assumed that devices 102, 108, control points 104 and 110, and device 116 are all online):
Step 200: A first user starts application 100.
Step 202: A second user starts application 106.
Step 204: The application 100 performs some processing and sends the updates of the states of the device 116, 120 and 122 to the control point 104.
Step 206: The coordinator 112 initializes a transaction session on itself. The transaction session prevents other transaction sessions to start. If there are other transaction sessions, they must wait until the current transaction session finishes. This prevents the data corruption in the local data storage.
Step 208: The coordinator 112 multicasts the start transaction session message to the coordinator 114. This message tells the coordinator 114 that there is a request of another transaction.
Step 209: It is determined if the coordinator 114 has another transaction session in progress, if so, the message is placed in a queue such that it can be processed at a later time on the coordinator 114 (step 300).
Step 210: Otherwise, the coordinator 114 initializes a transaction session. The transaction session blocks other transaction sessions until it completes.
Step 212: The coordinator 112 updates its data storage regarding to the states of device 116, 120, and 122; and events regarding to the state changes of device 116, 120, and 122.
Step 214: The coordinator 112 multicasts the updates of device 116, 120 and 122 to the coordinator 114.
Step 216: The coordinator 114 receives the updates. If there is no transaction that is being processed on the coordinator 114, the coordinator 114 updates its data storage with regard to device 116, 120 and 122.
Step 302: Otherwise, the coordinator 114 places the updates in its queue.
Step 218: The coordinator 112 completes the current transaction and picks the next blocking transaction in the queue for processing.
Step 220: The coordinator 112 multicasts the “complete transaction” session message to the coordinator 114. This message tells the coordinator 114 of the end of the previous “transaction-of-the-transaction” request.
Step 222: The coordinator 114 receives the message. If the current transaction session matches the transaction session on the coordinator 114, then coordinator 114 signals it has completed the current transaction session such that other blocked transaction sessions can proceed.
Step 304: Otherwise, the coordinator 114 places the transaction request message, which contains the runtime data and event notification occurrence information in the coordinator 112, in its queue.
Step 224: The coordinator 112 monotonically increases its transaction sequence number by 1.
Step 226: If the coordinator 114 finishes the current transaction, it monotonically increments its transaction sequence number by 1.
Step 306: The coordinator 114 finishes the current transaction, and increases the transaction sequence number by 1.
Step 308: The coordinator 114 looks into its queue. If there are transaction request messages in the queue, it starts another transaction from the queue.
Step 310: The coordinator 114 fetches the subsequent messages from its queue until the message indicates the completion of a transaction.
Step 312: When completed a transaction, the coordinator 114 monotonically increments its transaction sequence number by 1.
Step 228: The control point 104 generates an event as the result of updates of the device 116.
Step 320: The control point 104 sends the event back to the application 100.
Step 232: The coordinator 112 multicasts the event to the control point 110.
Step 234: The coordinator 114 receives the event from the control point 104.
Step 236: The control point 110 delivers the event to the application 106.
Step 238: Periodically, the coordinator 112 multicasts its current transaction sequence number to the coordinator 114.
Step 240: Likewise, the coordinator 114 multicasts its current transaction sequence number to the coordinator 112.
Step 242: At certain interval (e.g., every 10 minutes), the coordinator 112 compares its local transaction sequence number with the transaction sequence number from the coordinator 114.
Step 244: If the local transaction sequence number is smaller than the transaction sequence number from the coordinator 114 update messages have been lost, the coordinator 112 downloads the entire runtime states (e.g., the states of device 116, 120, and 122 and functional occurrences (e.g., events occurrence regarding to state changes of device 116, 120, and 122) from the coordinator 114.
Step 246: Likewise, at certain interval, the coordinator 114 compares its local transaction sequence number with the transaction sequence number from the coordinator 112.
Step 248: If the local transaction sequence number is smaller than the transaction sequence number from the coordinator 112, the coordinator 114 downloads the entire runtime states from the coordinator 114.

As a result of such operations described above, the control points 106 and 110 coordinate with each other for their runtime states and functions while function independently. Though FIG. 1 shows two control points, as those skilled in the art recognize the present invention is applicable to networks with three or more control points and multiple applications and devices. As such, the present invention is not limited to the example embodiment shown in FIGS. 1-3 and described herein.

An alternative approach is to keep strict consistency of data replication. One example is to use a token ring, wherein the token ring acts as a global lock. Before starting a transaction, the control point must obtain the token ring. After the token ring is obtained, the control point starts a transaction. When finishing the local transaction, the control point must listen for messages from other control points to indicate that they need to complete the transaction. If one of the control points indicates that the transaction fails, the control point must abort the current transaction, and send messages to other control point to abort the transaction as well. If the token ring is lost in the network, a new token ring must be generated by the cooperation of control points. This alternative approach, however, is slower than the preferred approach above. But it has the advantage of keeping data replication strictly consistent at any given time.

Another alternative approach is to design the coordination in a master/slave scheme. A master control point is elected among multiple control points. A transaction always starts from the master control point, and data is subsequently updated to slave control points. In a case the master control point becomes unavailable (e.g., crashes, powered down, etc.) a new master control point must be re-elected among living control points.

As the above example embodiment show, the present invention provides a distributed system that does not have a single point of failure. The distributed system enables multiple control points to coordinate each other with regard to runtime states. Therefore, one control point being powered off/out-of-service does not mean the devices in a home network cannot function properly or that their state is lost. Instead, other control points can continue to serve user requests from the point where the out-of-service control point left off. Another advantage is allowing for load balancing among multiple control points according to the present invention. Load balancing is important for control points in a home network environment because load balancing affects user perception of device responsiveness, especially for audio and video entertainment where real time response is required.

Although in this description embodiments of the present invention are described in relation to a home network, the present invention is not limited to a home network. As those skilled in the art will recognize, the present invention is applicable and useful to other network environments as well, such as enterprise network environment.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of control point coordination in a network including multiple control points and multiple devices, comprising the steps of:
distributing control point runtime states and functional coordination among the multiple control points such that every control point contains entire runtime states of all control points in the network.

2. The method of claim 1 wherein runtime data comprises devices states.

3. The method of claim 1 wherein runtime data comprises applications states.

4. The method of claim 1 wherein runtime data comprises functional coordination information.

5. The method of claim 1 further including the steps of:
each control point using said devices states, application states and functional coordination information for functioning independently of other control points.

6. The method of claim 1 wherein functional coordination includes the steps of:
synchronization of occurrence of event notifications to that in the control point.

7. The method of claim 6 wherein the steps of distributing functional coordination further include the steps of distributing functional coordination using a weak consistency model to replicate functional coordination information among heterogeneous control points.

8. The method of claim 7 further comprising the steps of:
the control points keep consistency for runtime states and deliver expected services independently and collaboratively.

9. The method of claim 8 wherein the steps of delivering expected services independently further includes the steps of each control point operating independently such that any one of the control points can control the devices in the network.

10. The method of claim 8 wherein the steps of delivering expected services collaboratively further includes the steps of a plurality of the control points coordinating each other.

11. The method of claim 10 wherein the steps of delivering expected services collaboratively further includes the steps of a plurality of the control points coordinating each other in terms of distributed device data and functions.

12. A coordinating system for a network including multiple devices and control points, comprising:
a distributed middleware implemented in the control points to coordinate the runtime data and functions of the control points such that the control points respond to service requests in consistent and independent manner.

13. The system of claim 12 wherein the distributed middleware operates to enable a first application to save its runtime data in a first control point wherein the first control point coordinates with a second control point to allow a second application that connects to the second control point to query the second control point about the first application.

14. The system of claim 13 wherein the application receives events from the second control point, wherein the events are generated by the first application.

15. The system of claim 13 wherein the first application generates the events and the first control point propagates those events to the second control point.

16. The system of claim 12 wherein the distributed middleware distributes data and functional coordination among the multiple control points such that data about devices and functions are duplicated among the multiple control points.

17. The system of claim 16 wherein the distributed middleware implements a weak consistency model to replicate data and coordinated functions among the control points.

18. The system of claim 17 wherein according to the weak consistency model a data write transaction on a control point is atomic such that a second data write transaction cannot commence if a control point is in the process of the first data write transaction.

19. The system of claim 18 wherein to ensure atomic data write transaction the control points use a series of messages are used to indicate the start and the end of a transaction.

20. The system of claim 19 wherein when a control point receives a start-of-a-transaction request message, that control point can start the transaction if there is no another transaction that is being processed by that control point, otherwise, the control point places the request message into a transaction queue for later processing.

21. The system of claim 17 wherein after a time period data on control points reach convergence such that data are same on every control point.

22. The system of claim 17 wherein according to the weak consistency model each data write transaction in a control point is recorded in conjunction with a monotonically increasing number that represents the order of occurrence of that data write transaction.

23. The system of claim 22 wherein the number is used by the control point for comparison of number of transactions that have been processed.

24. The system of claim 23 wherein if the compared numbers match, then data is coordinated among control points, otherwise, a control point with a smaller sequence number requests a control point with largest sequence number for the latest copy of the data.
